(19) United States
(12) Patent Application Publication
(10) Pub. No.: US 2026/0140467 A1
(43) Pub. Date: May 21, 2026

(54) FIXING DEVICE

(71) Applicant: CANON KABUSHIKI KAISHA, Tokyo (JP)

(72) Inventors: TAKASHI KIMURA, Tokyo (JP); EITA KAWASAKI, Kanagawa (JP); GOSHI OZAKI, Kanagawa (JP); MIKA MAEJIMA, Tokyo (JP); MASAFUMI MAEDA, Kanagawa (JP); KENICHI TAGAMI, Tokyo (JP)

(21) Appl. No.: 19/385,724

(22) Filed: Nov. 11, 2025

(30) Foreign Application Priority Data
Nov. 21, 2024 (JP) 2024-203408

(51) Int. Cl. G03G 15/20; G03G 15/00; G03G 21/16

(52) U.S. Cl. CPC G03G 15/2032; G03G 15/2064; G03G 15/80; G03G 21/1619; G03G 21/1647; G03G 2215/2035

(57) ABSTRACT

A fixing device includes a heating unit including a belt and a heater configured to heat the belt, a pressing roller configured to form a nip in cooperation with the heater and with the belt in between, an electrically conductive pressing spring configured to urge a pressing arm such that the heating unit is pressed against the pressing roller, an electrically conductive bearing supporting a rotary shaft of the pressing roller, a frame made of resin and supporting the bearing, an electrically conductive brush member provided in contact with the belt, a first conductor portion provided in contact with both the brush member and the pressing spring.

### BACKGROUND

### Field of the Technology

The present disclosure relates to an electrophotographic image forming apparatus.

### Description of the Related Art

Japanese Patent Laid-Open No. 2024-31208 discusses a fixing device that includes a heating unit and a pressing roller. The heating unit includes a heater configured to heat the inner surface of a belt. The pressing roller is configured to form a nip in cooperation with the heater and with the belt in between. The fixing device is configured to fix toner on a recording material.

### SUMMARY

The present disclosure provides a fixing device that overcomes shortcomings of the related art.

An aspect of the present disclosure provides
a fixing device configured to attach to an image forming apparatus, the fixing device including
a heating unit including a belt and a heater, the heater being configured to heat the belt; a pressing roller configured to form a nip in cooperation with the belt;
a pressing arm configured to press the heating unit against the pressing roller;
an electrically conductive pressing spring configured to urge the pressing arm such that the heating unit is pressed against the pressing roller;
an electrically conductive bearing configured to support a rotary shaft of the pressing roller;
a frame made of resin and supporting the bearing;
an electrically conductive brush member provided in contact with the belt;
a first conductor portion provided in contact with the brush member and the pressing spring such that the brush member and the pressing spring are electrically connected to each other;
a second conductor portion provided in contact with the pressing spring and a body conductor portion of the image forming apparatus such that the pressing spring and the body conductor portion are electrically connected to each other; and
a third conductor portion provided in contact with the first conductor portion and the bearing such that the rotary shaft and the body conductor portion are electrically connected to each other.

Features of the present disclosure will become apparent from the following description of embodiments with reference to the attached drawings. The following description of embodiments is described by way of example.

### BRIEF DESCRIPTION OF THE DRAWINGS

FIG. 1A is a perspective view of a fixing device according to a first embodiment.

FIG. 1B is another perspective view of the fixing device according to the first embodiment.

FIG. 2 is a sectional view of an image forming apparatus to which the fixing device according to the first embodiment is applied.

FIG. 3 is a sectional view of the fixing device according to the first embodiment.

FIG. 4 is another sectional view of the fixing device according to the first embodiment.

FIG. 5 is an exploded perspective view of the fixing device according to the first embodiment.

FIG. 6A is a perspective view of the fixing device according to the first embodiment.

FIG. 6B is another perspective view of the fixing device according to the first embodiment.

FIG. 7 is a top view of the fixing device according to the first embodiment.

FIG. 8 is a perspective view of the fixing device according to the first embodiment.

FIG. 9 is a sectional view of the fixing device according to the first embodiment.

FIG. 10A is a front view of a contact-point spring according to the first embodiment.

FIG. 10B is a plan view of the contact-point spring according to the first embodiment.

FIG. 11A is a front view of the fixing device according to the first embodiment.

FIG. 11B is a sectional view of the fixing device according to the first embodiment, taken along line XIB-XIB given in FIG. 11A.

FIG. 11C is a sectional view of the fixing device according to the first embodiment, taken along line XIC-XIC given in FIG. 11A.

FIG. 11D is a sectional view of the fixing device according to the first embodiment, taken along line XID-XID given in FIG. 11A.

FIG. 12A is a sectional view of the fixing device according to the first embodiment.

FIG. 12B is another sectional view of the fixing device according to the first embodiment.

FIG. 13 is an exploded perspective view of the fixing device according to the first embodiment.

FIG. 14 is a plan view of the fixing device according to the first embodiment.

FIG. 15 is another plan view of the fixing device according to the first embodiment.

FIG. 16 is yet another plan view of the fixing device according to the first embodiment.

FIG. 17 is yet another plan view of the fixing device according to the first embodiment.

FIG. 18 is a perspective view of the fixing device according to the first embodiment.

FIG. 19 is another perspective view of the fixing device according to the first embodiment.

FIG. 20 is a plan view of a fixing device according to a second embodiment.

FIG. 21 is another plan view of the fixing device according to the second embodiment.

FIG. 22 is yet another plan view of the fixing device according to the second embodiment.

FIG. 23 is a plan view of a fixing device according to a third embodiment.

FIG. 24A is a sectional view of part of a fixing device according to a fourth embodiment.

FIG. 24B is a plan view of part of the fixing device according to the fourth embodiment.

### DESCRIPTION OF THE EMBODIMENTS

Embodiments of the present disclosure will now be described with reference to the attached drawings. The dimensions, materials, shapes, relative positions, and other factors of elements to be described in the following embodiments may be changed as appropriate depending on the configuration and/or conditions employed in an apparatus to which the present disclosure is applied. Therefore, the scope of the present disclosure is not limited to the following embodiments unless otherwise specified.

### First Embodiment

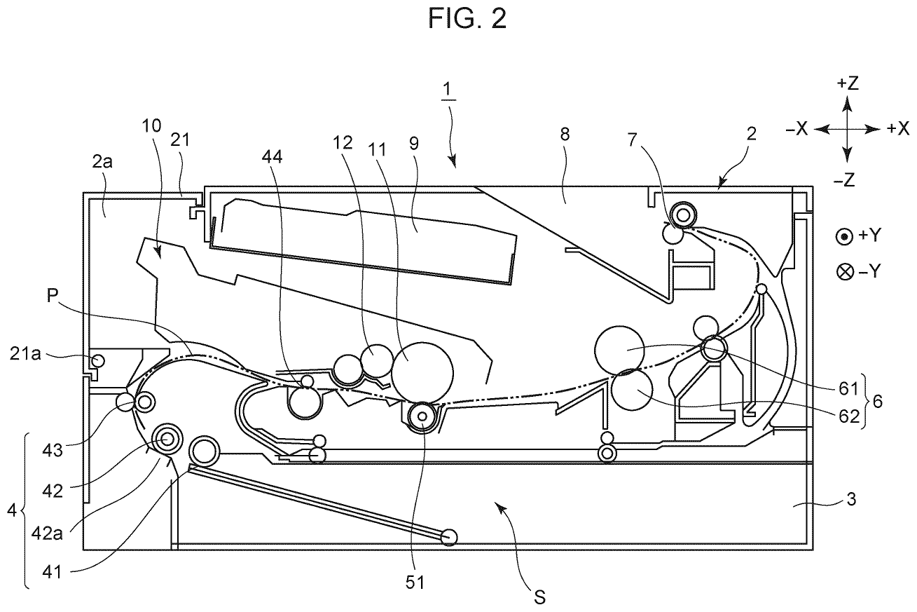

FIG. 2 is a sectional view of an electrophotographic image forming apparatus 1 to which a fixing device 6 according to a first embodiment is applied. In the following description, with the image forming apparatus 1 installed horizontally as illustrated in FIG. 2, the vertical direction is the Z direction, as indicated in FIGS. 2-6B, 8-9, 11A, 12A-22 and 24A. The Y direction intersects the Z direction and is parallel to the rotation-axis direction of a pressing arm 652, described below. The X direction intersects both the Z direction and the Y direction. The X direction is parallel to a direction in which a heating unit 61 conveys a recording material, also referred to as a sheet S, at a nip np1, as described below. The X direction and the Y direction may each correspond to a horizontal direction. The X direction, the Y direction, and the Z direction may be orthogonal to each other. Some of the drawings have arrows representing the X, Y, and Z directions, with one side of each arrow denoted as a corresponding one of +X, +Y, and +Z and the other as a corresponding one of −X, −Y, and −Z. In the following description, the direction in which the recording material is conveyed at the nip np1 is referred to as a recording-material conveyance direction (+X direction). The +X direction coincides with a direction in which the fixing device 6 is attached to an apparatus body 2, and may also be referred to as the attaching direction in the following description. The rotation-axis direction of the pressing arm 652, described below, is also referred to as an axial direction. With respect to the axial direction, a direction from the heating unit 61 toward an electrical contact point 668b1 is referred to as a first axial direction (+Y direction). With respect to the axial direction, a direction opposite to the first axial direction is referred to as a second axial direction (−Y direction). The Y direction coincides with the longitudinal direction of the heating unit 61. The Y direction also coincides with a generating-line direction of a belt 614. With respect to the longitudinal direction of the heating unit 61, a direction from a contact-point spring 668 toward the longitudinal center of the heating unit 61 is referred to as a first direction (−Y direction).

### (Image Forming Apparatus)

A configuration of the image forming apparatus 1 will now be described with reference to FIG. 2. The image forming apparatus 1 includes an apparatus body 2, a process cartridge 10, and the fixing device 6. The process cartridge 10 is detachably attached to the apparatus body 2. The fixing device 6 is detachably attached to the apparatus body 2. The fixing device 6 is included in the apparatus body 2. The fixing device 6 may be configured to not be detachable from the apparatus body 2.

The apparatus body 2 includes a sheet feeding tray 3, a sheet feeder 4, a conveyance path P, a transfer roller 51, a sheet discharger 7, a sheet receiving tray 8, a laser scanner 9, and a door 21. The process cartridge 10 includes a photoconductor drum 11 and a developing roller 12. The developing roller 12 serves as a developer carrier. Developer (also referred to as toner) is accommodated inside the process cartridge 10. The door 21 is supported in such a manner as to be rotatable about a rotation shaft 21a and is movable between a closed position where an opening 2a is closed and an open position where the opening 2a is exposed. With the door 21 in the open position with the opening 2a exposed, the process cartridge 10 is attachable to and detachable from the apparatus body 2 through the opening 2a.

The sheet feeder 4 includes a sheet feeding roller 41, a separating roller 42, a separating pad 42a, and a conveying-roller pair 43. In response to a print-start signal, a sheet S accommodated in the sheet feeding tray 3 is delivered to a conveyance path P by the sheet feeder 4 and is conveyed through a registration-roller pair 44 toward the transfer roller 51.

When the sheet S reaches a predetermined position, an image-formation start signal is issued, whereby an image forming process is started. The photoconductor drum 11 is rotated by a drive source (e.g., a motor) and is uniformly charged by a charger to have a predetermined potential. The laser scanner 9 exposes the charged surface of the photoconductor drum 11 with light generated on the basis of image information, whereby an electrostatic latent image is formed with the removal of electric charge from the exposed portion. The toner accommodated in the process cartridge 10 is carried by the developing roller 12 and is supplied to the photoconductor drum 11 in conformity with the electrostatic latent image, whereby the electrostatic latent image is developed into a toner image and is visualized on the photoconductive drum 11.

The transfer roller 51 is located facing the photoconductor drum 11 included in the process cartridge 10. When the sheet S conveyed by the registration-roller pair 44 passes through a nip formed between the photoconductor drum 11 and the transfer roller 51, a voltage is applied from the apparatus body 2 to the transfer roller 51, whereby the toner image on the photoconductor drum 11 is transferred as an unfixed image to the sheet S. The sheet S having the toner image transferred thereto is then conveyed to the fixing device 6, which includes the heating unit 61 and a rotary pressing member 62. The fixing device 6 is a device configured to fix toner (developer) to a recording material. When the sheet S passes through the nip np1 formed between the heating unit 61 and the rotary pressing member 62, the unfixed image on the sheet S is heated and pressed, and is thus fixed to the surface of the sheet S. The sheet S having the fixed toner image is conveyed by the sheet discharger 7 and is discharged onto the sheet receiving tray 8.

### (Fixing Device)

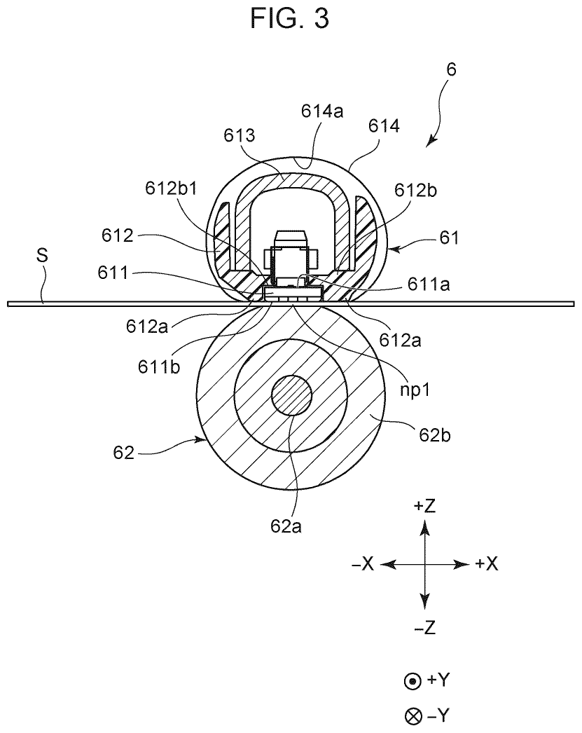

A configuration of the fixing device 6 will now be described. FIG. 3 is a sectional view of the fixing device 6. As illustrated in FIG. 3, the heating unit 61 includes a heater 611, a holder 612, a stay 613, and the belt 614. The heater 611 is provided on the inner side of the belt 614 and is configured to heat the belt 614. The heater 611 extends in the generating-line direction of the belt 614 (the Y direction) and has a flat plate shape. The heater 611 has a first surface 611a and a second surface 611b, which is located opposite the first surface 611a. The heater 611 is supported at the first surface 611a by the holder 612.

The holder 612 is made of a heat-resistant resin such as poly (p-phenylene sulfide) (PPS) or liquid crystal polymer and includes a guide surface 612a and a support wall 612b. The guide surface 612a guides the belt 614 while being in contact with an inner peripheral surface 614a of the belt 614. The support wall 612b has a support surface 612b1, at which the heater 611 is supported. The support surface 612b1 of the support wall 612b is in contact with the first surface 611a of the heater 611. The stay 613 supports the holder 612 and is made of a plate having a greater rigidity than the holder 612. For example, a steel plate having a thickness of 1.6 mm is bent into a substantially U shape, whereby the stay 613 is obtained.

The belt 614 is an endless belt having heat resistance and flexibility. The belt 614 may be, for example, a metal sleeve made of stainless steel or the like and coated with fluorocarbon resin, or a stack of polyimide resin, silicone rubber, fluorocarbon resin, and/or the like. The belt 614 surrounds the heater 611, the holder 612, and the stay 613 and is caused to rotate around the heater 611, the holder 612, and the stay 613. The inner peripheral surface 614a of the belt 614 is in contact with the second surface 611b of the heater 611.

The rotary pressing member 62 (pressing roller) includes a shaft 62a made of metal, and a roller 62b made of an elastic material and covering the shaft 62a. The rotary pressing member 62 is pressed against the heater 611 with the belt 614 in between. The rotary pressing member 62 cooperates with the heater 611 to nip the belt 614 in between, thereby forming the nip np1 where the sheet S is to be nipped under heat and pressure. The rotary pressing member 62 (pressing roller) is configured to form the nip np1 in cooperation with the heater 611 and with the belt 614 in between. That is, the rotary pressing member 62 and the heater 611 cooperate to heat and press the sheet S at the nip np1.

The rotary pressing member 62 is configured to rotate by receiving a driving force transmitted from a drive source included in the image forming apparatus 1. With the rotation of the rotary pressing member 62, the belt 614 rotates in such a manner as to follow the rotary pressing member 62. The sheet S having the toner image transferred thereto is conveyed between the rotary pressing member 62 and the heated belt 614, whereby the toner image is thermally fixed.

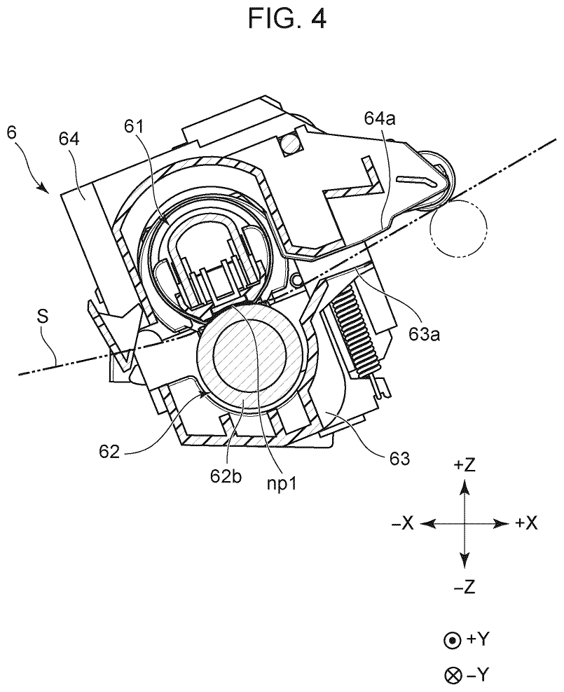

Referring to FIG. 4, a frame structure of the fixing device 6 will be described. FIG. 4 is a sectional view of the fixing device 6. The fixing device 6 includes an upper frame 64 and a lower frame 63. The upper frame 64 may also be referred to as a first frame, and the lower frame 63 may also be referred to as a second frame. The lower frame 63 supports the heating unit 61 and the rotary pressing member 62. The upper frame 64 (first frame) is located above the lower frame 63 (second frame) and covers the heating unit 61. The lower frame 63 and the upper frame 64 are each formed as a nonconductive molded member made of resin. The upper frame 64 includes an upper guide surface 64a located downstream of the heating unit 61 in the recording-material conveyance direction (+X direction). The upper guide surface 64a guides the sheet S that is being conveyed in the recording-material conveyance direction at a surface (upper surface) of the sheet S that faces the heating unit 61. The lower frame 63 includes a lower guide surface 63a located downstream of the heating unit 61 in the recording-material conveyance direction. The lower guide surface 63a guides the lower surface of the sheet S that is being conveyed in the recording-material conveyance direction.

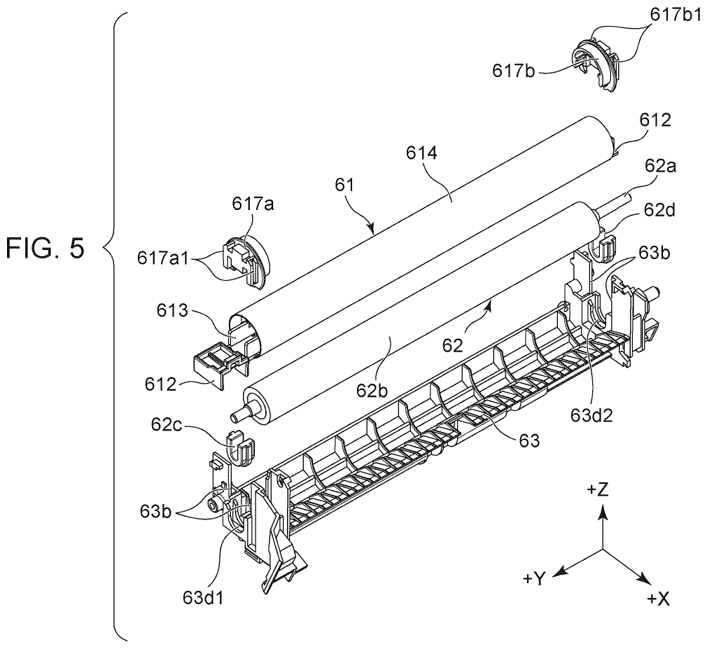

Referring to FIG. 5, a configuration of the lower frame 63 that supports the rotary pressing member 62 will be described. FIG. 5 is an exploded perspective view of the fixing device 6. The lower frame 63 includes a rail 63b at each end thereof on the first-axial-direction side and an end thereof on the second-axial-direction side. The rails 63b extend in the vertical direction and support the holder 612 while allowing the holder 612 to move in the vertical direction. The rails 63b are opposite each other in the axial direction. The rails 63b are in engagement with grooves 617al and 617b1 provided in respective transmission members 617a and 617b.

The fixing device 6 includes bearings 62c and 62d. An end of the shaft 62a that is located on the first-axial-direction side and an end of the shaft 62a that is located on the second-axial-direction side are supported by the respective bearings 62c and 62d. The bearing 62c is positioned by being fitted in a recess 63d1 provided in the lower frame 63. Likewise, the bearing 62d is positioned by being fitted in a recess 63d2 provided in the lower frame 63. The bearing 62c is electrically conductive. In the present configuration, the bearings 62c and 62d have protrusions while the lower frame 63 has the recesses 63d1 and 63d2. The locations of the protrusions and the recesses may be exchanged. Moreover, the elements that secure the bearings 62c and 62d to the lower frame 63 do not necessarily need to be protrusions and recesses.

### (Pressing Mechanism)

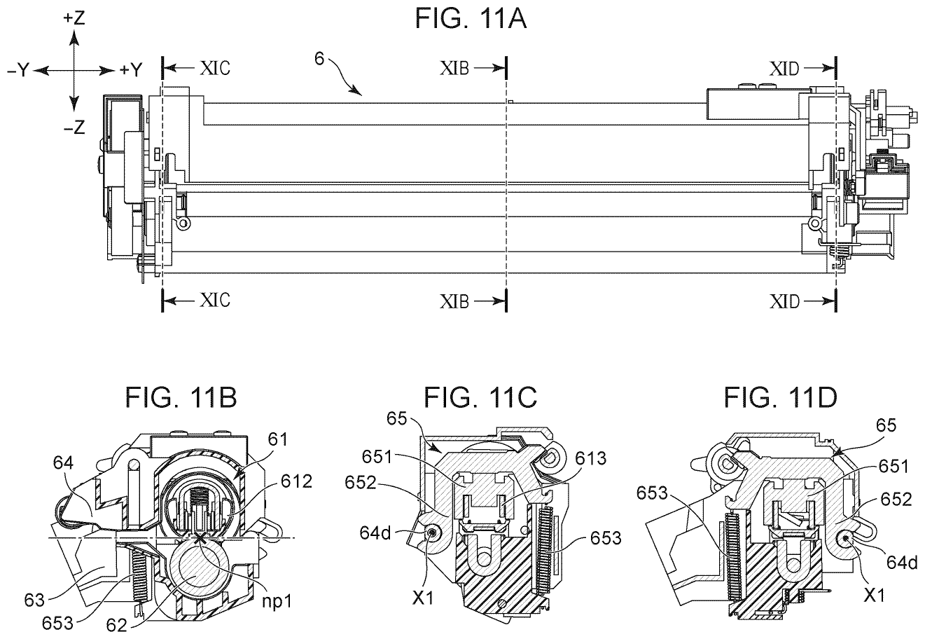

A configuration of a pressing mechanism 65 included in the fixing device 6 will now be described. FIG. 11A is a front view of the fixing device 6. FIGS. 11B to 11D illustrate respective sections taken from FIG. 11A.

As illustrated in FIGS. 11A to 11D, the fixing device 6 includes the pressing mechanism 65, which is configured to press the heating unit 61 against the rotary pressing member 62. The pressing mechanism 65 is provided at each of two ends of the lower frame 63 that are located on the first-axial-direction side and on the second-axial-direction side. In other words, the pressing mechanisms 65 are supported by the lower frame 63. The pressing mechanism 65 at the end of the lower frame 63 on the first-axial-direction side has substantially the same configuration as the pressing mechanism 65 at the end of the lower frame 63 on the second-axial-direction side. The following description of the pressing mechanism 65 at the end on the first-axial-direction side also applies to the pressing mechanism 65 at the end on the second-axial-direction side, and redundant description is incorporated herein by reference, for conciseness.

The pressing mechanisms 65 each include a transmission member 651, the pressing arm 652, and a pressing spring 653. The pressing arm 652 is supported by the lower frame 63. More specifically, the pressing arm 652 is supported by a supporting portion 64d of the lower frame 63 and is rotatable about a center axis X1 of the supporting portion 64d. The supporting portion 64d is a substantially circular columnar projection.

The pressing arm 652 presses the transmission member 651 from above to move the transmission member 651 downward. Accordingly, the transmission member 651 presses the stay 613 downward. The transmission member 651 pressing the stay 613 moves the stay 613 downward. With the downward movement of the stay 613, the heating unit 61, including the stay 613, is pressed against the rotary pressing member 62. The pressing spring 653 is an electrically conductive helical extension spring that urges the pressing arm 652 such that the heating unit 61 is pressed against the rotary pressing member 62. The pressing spring 653 is in engagement with the lower frame 63 and the pressing arm 652. With the pressing spring 653 urging the pressing arm 652, the pressing arm 652 moves the transmission member 651 downward. That is, the pressing arm 652 presses the heating unit 61 against the rotary pressing member 62 (pressing roller).

### (Pressing/Releasing Mechanism)

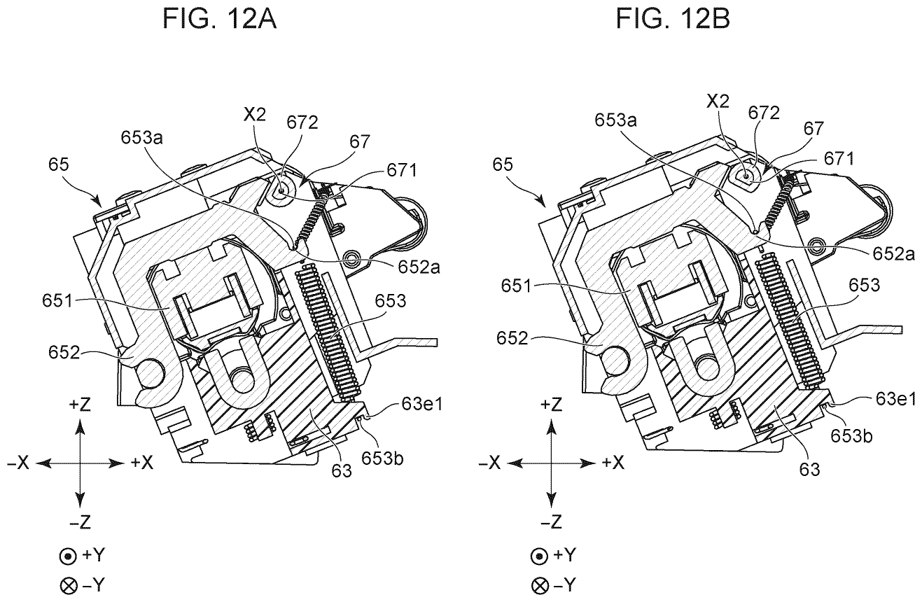

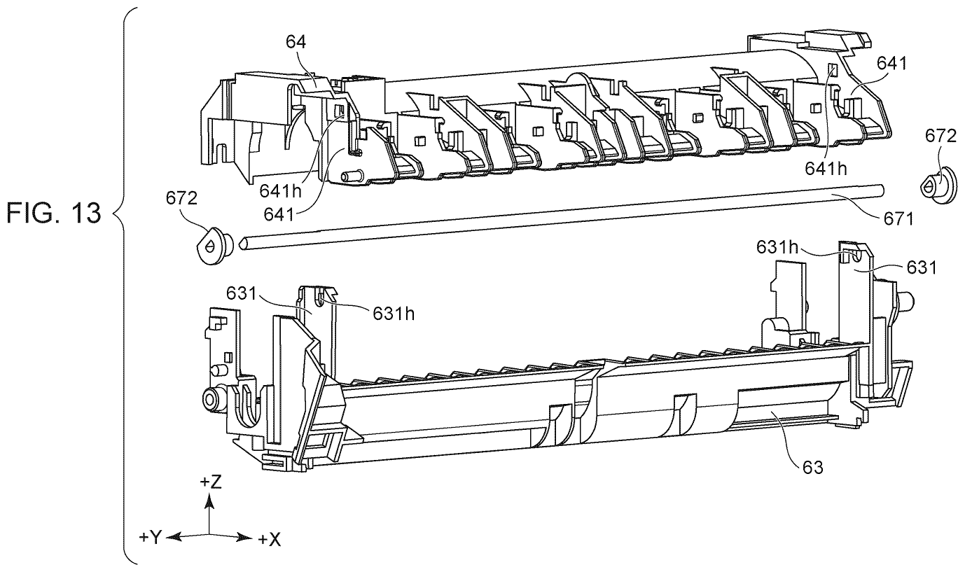

Referring to FIGS. 12A and 12B and FIG. 13, a configuration of a pressing/releasing mechanism 67 included in the fixing device 6 will be described. FIGS. 12A and 12B are sectional views of the fixing device 6. FIG. 12A illustrates a pressed state in which the pressing by the pressing/releasing mechanism 67 is enabled. FIG. 12B illustrates a released state in which the pressing by the pressing/releasing mechanism 67 is disabled. FIG. 13 is an exploded perspective view of the fixing device 6, illustrating the upper frame 64, the lower frame 63, and a cam shaft 671 but not illustrating some components such as the heating unit 61 and the rotary pressing member 62. The pressing/releasing mechanism 67 is a nipping-pressure-applying/removing mechanism configured to change the nipping pressure to be generated at the nip np1 formed between the heating unit 61 and the rotary pressing member 62. The pressing/releasing mechanism 67 includes the cam shaft 671 and cams 672.

Referring to FIGS. 12A and 12B, the cam shaft 671 is rotatable about an axis X2. The cam shaft 671 extends in the axial direction and is made of an electrically conductive metal. As illustrated in FIG. 13, the cams 672 are fixed to (supported at) respective ends of the cam shaft 671 that are located on the first-axial-direction side and on the second-axial-direction side. The cams 672 are supported in such a manner as to rotate together with the cam shaft 671. The cams 672 are provided at respective ends of the lower frame 63 that are located on the first-axial-direction side and on the second-axial-direction side. The cam 672 provided at the end of the lower frame 63 on the first-axial-direction side and the cam 672 provided at the end of the lower frame 63 on the second-axial-direction side have substantially the same configuration.

Each cam 672 is pressing the pressing arm 652 against the urging force exerted by the pressing spring 653. Accordingly, the rotation of the cam 672 changes the pressing force exerted by the pressing arm 652 on the rotary pressing member 62 of the heating unit 61. The cam 672 is rotatable between a pressing position illustrated in FIG. 12A and a releasing position illustrated in FIG. 12B.

To disable the pressing, the cam shaft 671 is rotated, whereby the cam 672 rotates. When the cam 672 rotates, the pressing arm 652 that is in contact with the cam 672 moves away from the transmission member 651 in a direction opposite to the direction in which the stay 613 is pressed by the transmission member 651.

Accordingly, the force of pressing the heating unit 61 against the rotary pressing member 62 is reduced.

Referring to FIG. 13, a structure of supporting the cam shaft 671 will be described. The lower frame 63 includes a support wall 631 that supports the cam shaft 671 while allowing the cam shaft 671 to rotate. The support wall 631 extends in the vertical direction (Z direction). The support wall 631 has a hole 631h where the cam shaft 671 is rotatably supported. The cam shaft 671 extends through the hole 631h. Hence, the support wall 631 may also be referred to as a shaft supporting portion that supports the cam shaft 671. The support wall 631 is provided at each of two ends of the lower frame 63 that are located on the first-axial-direction side and on the second-axial-direction side. The holes 631h provided in the respective support walls 631 are substantially the same.

The upper frame 64 has a support wall 641 that supports the cam shaft 671 while allowing the cam shaft 671 to rotate.

The support wall 641 extends in the vertical direction. The support wall 641 has a hole 641h where the cam shaft 671 is rotatably supported. The cam shaft 671 extends through the hole 641h. The support wall 641 is provided at each of two ends of the upper frame 64 that are located on the first-axial-direction side and on the second-axial-direction side. The holes 641h provided in the respective support walls 641 are substantially the same.

### (Grounding Structure for Fixing Device)

A grounding structure provided for the fixing device 6 will now be described. The fixing device 6 according to the first embodiment includes a grounding structure for eliminating static electricity from the heating unit 61 of the fixing device 6. Static electricity that occurs in the fixing device 6 flows through a static eliminator 66 to the apparatus body 2.

### (Static Eliminator)

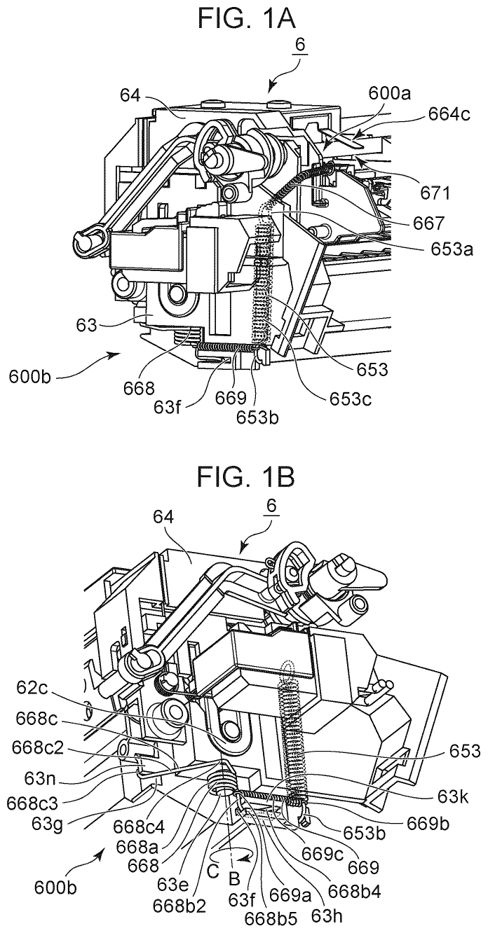

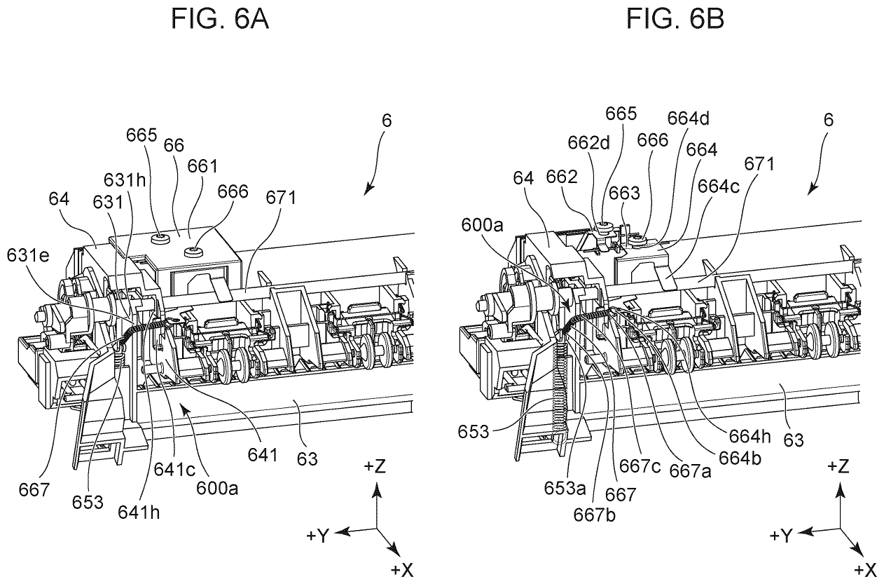

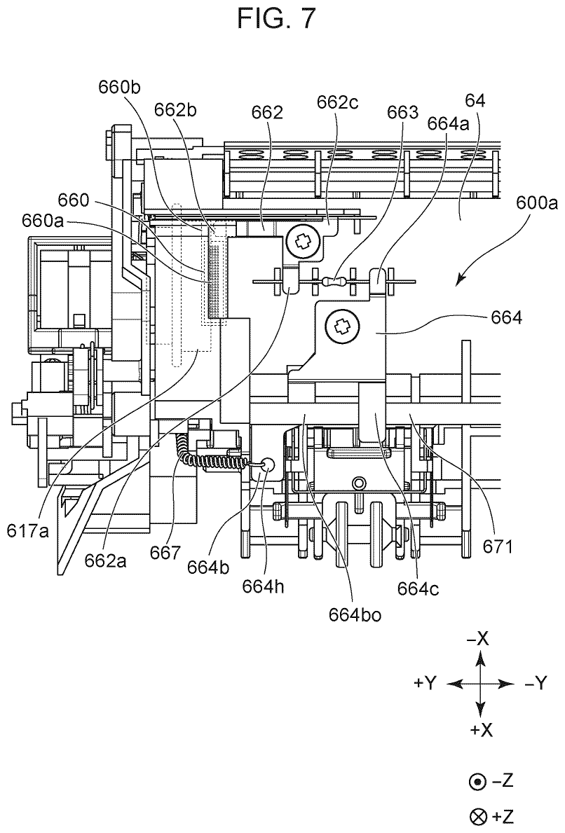

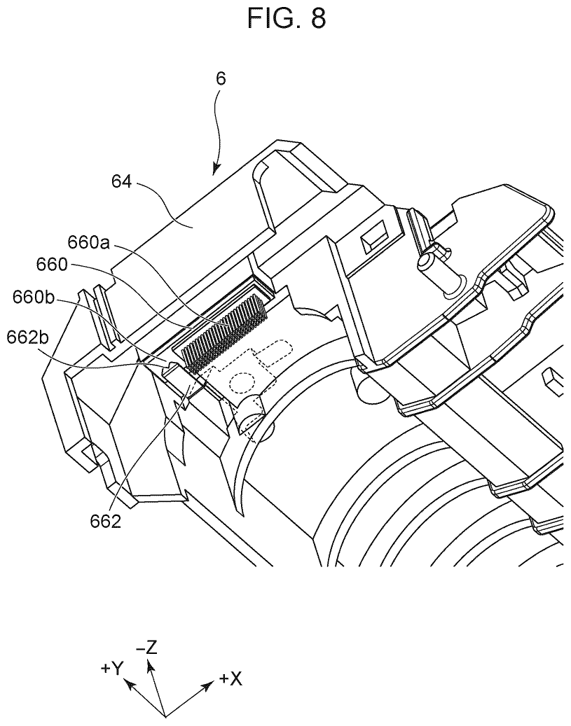

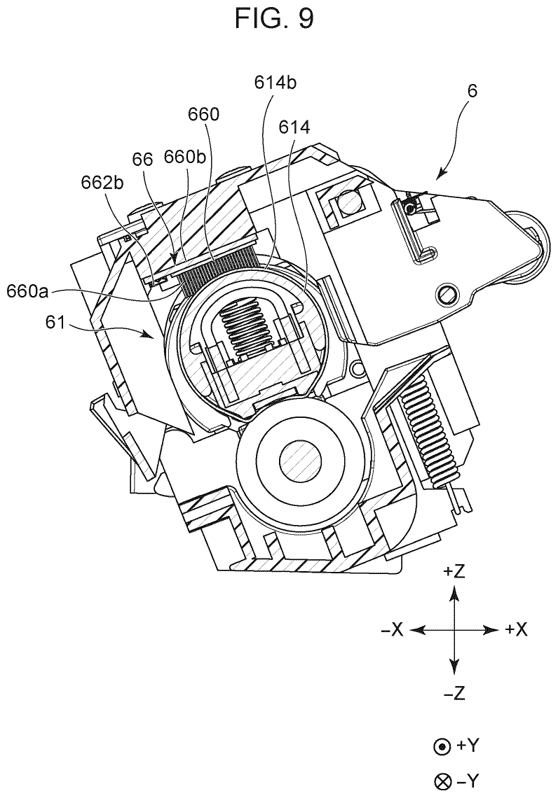

A configuration of the static eliminator 66 will now be described with reference to FIGS. 1A and 1B, FIGS. 6A and 6B, and FIGS. 7 to 9. FIGS. 1A and 1B are perspective views of the fixing device 6. FIG. 6A is another perspective view of the fixing device 6. FIG. 6B is yet another perspective view of the fixing device 6, with a cover 661 not illustrated. The cover 661 is illustrated in FIG. 6A. FIG. 7 is a top view of the fixing device 6. FIG. 8 is a perspective view of the fixing device 6. FIG. 9 is a sectional view of the fixing device 6.

As illustrated in FIG. 6A, the upper frame 64 is provided with the static eliminator 66 configured to eliminate static electricity from the fixing device 6. With respect to the first axial direction, the static eliminator 66 is located downstream of the midpoint of the belt 614 that is defined in the axial direction.

As illustrated in FIGS. 6A to 9, the static eliminator 66 includes a brush 660, a first conductive plate 662, a resistor 663, a second conductive plate 664, the cover 661, a screw 665, a screw 666, and a first conductive spring 667.

The brush 660 is in contact with the heating unit 61 and the first conductive plate 662. The first conductive plate 662 is in contact with the resistor 663. The second conductive plate 664 is in contact with the first conductive spring 667. The brush 660, the first conductive plate 662, the resistor 663, and the second conductive plate 664 each have electrical conductivity. Therefore, static electricity occurring in the heating unit 61 is transmitted from the brush 660 to the first conductive spring 667.

The cover 661 covers the brush 660, the first conductive plate 662, and the second conductive plate 664 from above. As illustrated in FIGS. 6A and 6B, the screw 665 fixes the first conductive plate 662 and the cover 661 to the upper frame 64. The screw 666 fixes the second conductive plate 664 and the cover 661 to the upper frame 64.

A configuration of the brush 660 (brush member) will now be described. As illustrated in FIG. 8, the brush 660 is fixed inside the upper frame 64. As illustrated in FIG. 9, the brush 660 is an electrically conductive member provided in contact with the belt 614, from above. The brush 660 includes a brush body 660a and a base plate 660b. The brush body 660a is made of an electrically conductive resin. The base plate 660b is made of a stainless steel called SUS, which is a metal, and has an electrical conductivity. The brush body 660a is in contact with an outer peripheral surface 614b (electrically conductive layer) of the belt 614, whereby the brush body 660a and the belt 614 are electrically continuous with, i.e. connected to, each other. That is, the brush 660 and the heating unit 61 are electrically continuous with each other. In the first embodiment, the brush body 660a is in contact with the outer peripheral surface 614b of the belt 614. Alternatively, another electrically conductive member may be interposed between the brush body 660a and the belt 614 so that the brush body 660a and the belt 614 are electrically continuous with each other. The base plate 660b is fixed to the brush body 660a and the upper frame 64. That is, the brush body 660a is fixed to the upper frame 64 with the aid of the base plate 660b. As illustrated in FIG. 8, the base plate 660b is in contact with a contact portion 662b of the first conductive plate 662, described below. That is, the base plate 660b and the first conductive plate 662 are electrically continuous with each other. As illustrated in FIG. 7, the brush body 660a is in contact with the transmission member 617a. More specifically, when viewed in the vertical direction (Z direction), at least a portion of the brush body 660a that is located on the first-axial-direction side overlaps the transmission member 617a.

Now, a configuration of the first conductive plate 662 will be described. As illustrated in FIG. 7, the first conductive plate 662, which is an electrically conductive member, is located upstream of the brush 660 in the first axial direction. As illustrated in FIG. 6B, the first conductive plate 662 has a first hole 662d. The screw 665 extends through the first hole 662d. Thus, the first conductive plate 662 is fixed to (supported by) the upper frame 64 with the aid of the screw 665. As illustrated in FIG. 7, the first conductive plate 662 includes a contact portion 662a, the contact portion 662b, and a contact portion 662c. The contact portion 662a is in contact with the resistor 663, described below. That is, the first conductive plate 662 is electrically continuous with the resistor 663. As illustrated in FIGS. 7 and 8, the contact portion 662b is in contact with the base plate 660b. That is, the contact portion 662b and the base plate 660b are electrically continuous with each other. Thus, the first conductive plate 662 is electrically continuous with the brush 660 and the resistor 663. Therefore, static electricity is allowed to flow from the brush 660 to the resistor 663.

Now, a configuration of the resistor 663 will be described. The grounding structure according to the first embodiment includes the resistor 663. Regulating electric current flow through the resistor 663 to the ground prevents the occurrence of damage to a protective layer formed on the surface of the heater 611. As illustrated in FIG. 7, the resistor 663, which has a predetermined electrical resistance, is pressed against the upper frame 64 by the contact portion 662a of the first conductive plate 662 and a contact portion 664a of the second conductive plate 664 and is thus fixed to the upper frame 64.

The resistor 663 is in contact with the contact portion 662a and is therefore electrically continuous with the first conductive plate 662. The resistor 663 is also in contact with the contact portion 664a of the second conductive plate 664, described below, and is therefore electrically continuous with the second conductive plate 664. Since the resistor 663 is electrically continuous with the first conductive plate 662 and the second conductive plate 664, static electricity is allowed to flow from the first conductive plate 662 to the second conductive plate 664.

Now, a configuration of the second conductive plate 664 will be described. As illustrated in FIG. 6B, the second conductive plate 664 has a second hole 664d. The screw 666 extends through the second hole 664d. Thus, the second conductive plate 664 is fixed to the upper frame 64 with the aid of the screw 665.

As illustrated in FIG. 7, the second conductive plate 664 is an electrically conductive member and includes the contact portion 664a, a contact portion 664b, and a contact portion 664c. The contact portion 664a is in contact with the resistor 663.

That is, the resistor 663 and the second conductive plate 664 are electrically continuous with each other. The contact portion 664b has a third hole 664h. A hook 667a of the first conductive spring 667, described below, extends through the third hole 664h and is in engagement with the contact portion 664b. The contact portion 664b is in contact with the hook 667a of the first conductive spring 667, described below. That is, the second conductive plate 664 and the first conductive spring 667 are electrically continuous with each other. Since the second conductive plate 664 is electrically continuous with the resistor 663 and the first conductive spring 667, static electricity is allowed to flow from the resistor 663 to the first conductive plate 667.

When viewed in the vertical direction, as illustrated in FIG. 7, the contact portion 664b includes an overlapping portion 664bo that overlaps the cam shaft 671. The overlapping portion 664bo is located below the cam shaft 671. Since the second conductive plate 664 is located below the cam shaft 671, the cam shaft 671 that is under rotation is less likely to interfere with the second conductive plate 664 than in a configuration in which the second conductive plate 664 is located above the cam shaft 671.

As illustrated in FIGS. 1A and 7, the contact portion 664c is in contact with the cam shaft 671 from above. The contact portion 664c may also be referred to as a cam-shaft contact portion. In such a configuration, electric charge accumulated in the cam shaft 671 is allowed to be released through the second conductive plate 664 and the pressing spring 653 to a body conductor portion 2A, described below. That is, the second conductive plate 664 according to the first embodiment not only releases electric charge accumulated in the heating unit 61 but also releases electric charge accumulated in the cam shaft 671.

Now, a configuration of the first conductive spring 667 will be described. The first conductive spring 667 is an electrically conductive member. As illustrated in FIG. 6B, the first conductive spring 667 includes a body spring 667c, the hook 667a, and a hook 667b.

The hook 667a forms one end of the first conductive spring 667. The hook 667b forms the other end of the first conductive spring 667. As described above, the hook 667a is in engagement with the contact portion 664b at the third hole 664h. The hook 667b is in engagement with an upper hook 653a of the pressing spring 653, described below. That is, the first conductive plate 667 is in contact with and electrically continuous with both the second conductive plate 664 and the pressing spring 653. The body spring 667c extends from the hook 667a and in the first axial direction and is connected to the hook 667b. That is, the first conductive spring 667 (first spring) extends in the rotation-axis direction of the pressing arm 652 and is electrically connected to the pressing spring 653.

Referring to FIGS. 6A and 6B, the positional relationship between the body spring 667c and the frames 63 and 64 will be described. The support wall 641 of the upper frame 64 has a groove-shaped portion 641c. The groove-shaped portion 641c is shaped to allow the body spring 667c to extend through the support wall 631 from the upstream side toward the downstream side in the first axial direction. The first conductive spring 667 extends through the groove-shaped portion 641c and in the first axial direction.

A portion of the support wall 631 of the lower frame 63 that is located at an end in the recording-material conveyance direction is referred to as a support downstream end 631e. As illustrated in FIGS. 6A, with respect to the recording-material conveyance direction, the support downstream end 631e is located between the cam shaft 671 and the first conductive spring 667 (first spring). The support downstream end 631e is in contact with the first conductive spring 667, thereby guiding the first conductive spring 667 while limiting the movement of the first conductive spring 667 toward the cam shaft 671. Such a configuration reduces interference between the first conductive spring 667 and the cam shaft 671 that is under rotation. In the first embodiment, the first conductive spring 667 is in contact with the support downstream end 631e. Alternatively, the first conductive spring 667 may be located further downstream of the support downstream end 631e in the recording-material conveyance direction in such a manner as to be out of contact with the support downstream end 631e.

Referring to FIGS. 1A and 1B, FIG. 7, and FIGS. 12A and 12B, the electrical continuity between the pressing spring 653 and other elements will be described. The pressing spring 653 includes the upper hook 653a, a lower hook 653b, and a body spring 653c. The upper hook 653a forms one end of the pressing spring 653, and the lower hook 653b forms the other end of the pressing spring 653. The body spring 653c is connected to the upper hook 653a and the lower hook 653b and extends downward (in the vertical direction). The pressing spring 653 extends downward from the upper hook 653a to the lower hook 653b. The upper hook 653a is in engagement with the hook 667b of the first conductive spring 667. A hook 669b, described below, of the second conductive spring 669 is in engagement with the lower hook 653b. Therefore, the pressing spring 653 is in contact with and electrically continuous with both the first conductive spring 667 and the second conductive spring 669.

As illustrated in FIGS. 12A and 12B, the pressing arm 652 has an arm engaging portion 652a in the form of a groove. The upper hook 653a is in engagement with and is thus supported by the arm engaging portion 652a. That is, the pressing spring 653 is in contact with and supported by the pressing arm 652. The lower frame 63 has a frame engaging portion 63e1 in the form of a groove. The lower hook 653b is in engagement with and supported by the frame engaging portion 63e1.

Referring to FIGS. 1A and 1B, the electrical continuity between the second conductive spring 669 and other elements will be described. The second conductive spring 669 includes a hook 669a, the hook 669b, and a body spring 669c. The hook 669a forms one end of the second conductive spring 669, and the hook 669b forms the other end of the second conductive spring 669. The body spring 669c is connected to the hook 669a and the hook 669b. The second conductive spring 669 extends in the recording-material conveyance direction from the hook 669a to the hook 669b. The hook 669a is in engagement with the contact-point spring 668, described below. As described above, the hook 669b is in engagement with the lower hook 653b. Therefore, the second conductive spring 669 is in contact with and electrically continuous with both the pressing spring 653 and the contact-point spring 668.

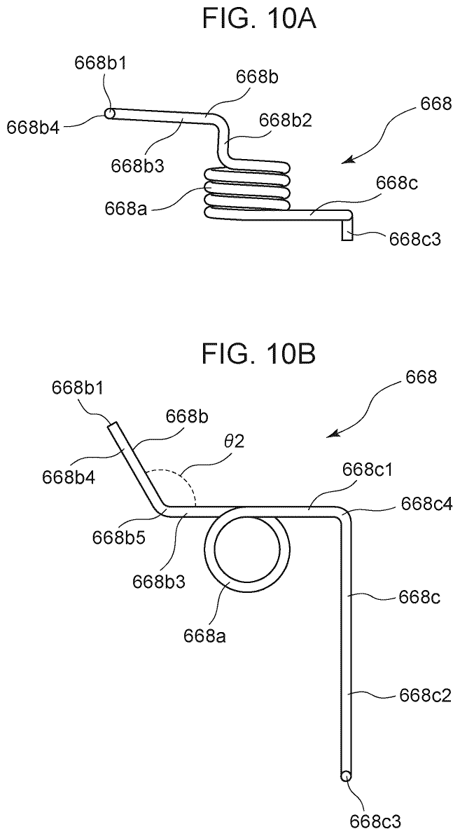

Referring to FIGS. 1A and 1B and FIGS. 10A and 10B, the electrical continuity between the contact-point spring 668 and other elements will be described. FIG. 10A is a front view of the contact-point spring 668. FIG. 10B is a top view of the contact-point spring 668.

The contact-point spring 668 is a helical torsion spring made of metal wire. The contact-point spring 668 includes a coil portion 668a, a first arm 668b extending from one end of the coil portion 668a toward the upstream side in the attaching direction, and a second arm 668c extending from the other end of the coil portion 668a toward the downstream side in the attaching direction. The coil portion 668a is wound around a boss 63e provided on the lower frame 63 and is thus supported by the lower frame 63. That is, the boss 63e is fitted in the coil portion 668a.

The first arm 668b includes a spring receiving portion 668b2, an extended portion 668b3, a first-arm distal portion 668b4, and a bent portion 668b5. The first arm 668b has at the distal end thereof the electrical contact point 668b1, which is to come into contact with the body conductor portion 2A of the apparatus body 2, described below. The first-arm distal portion 668b4 is a portion at the distal end of the first arm 668b. The electrical contact point 668b1 may also be regarded as the distal end of the first arm 668b. When the electrical contact point 668b1 comes into contact with the body conductor portion 2A, static electricity flows from the fixing device 6 to the apparatus body 2.

The spring receiving portion 668b2 extends from one end of the coil portion 668a and in the axial direction of the coil portion 668a. The extended portion 668b3 is angled with respect to the spring receiving portion 668b2 and extends in a direction intersecting the axial direction of the coil portion 668a. The first-arm distal portion 668b4 extends from the extended portion 668b3 while being angled with respect to the extended portion 668b3 at the bent portion 668b5, and further extends in a direction orthogonal to the axial direction of the coil portion 668a. The electrical contact point 668b1 forms the distal end of the first arm 668b and has a shape obtained by simply cutting the metal wire. That is, the electrical contact point 668b1 has a sharp edge without being subjected to a process such as rounding.

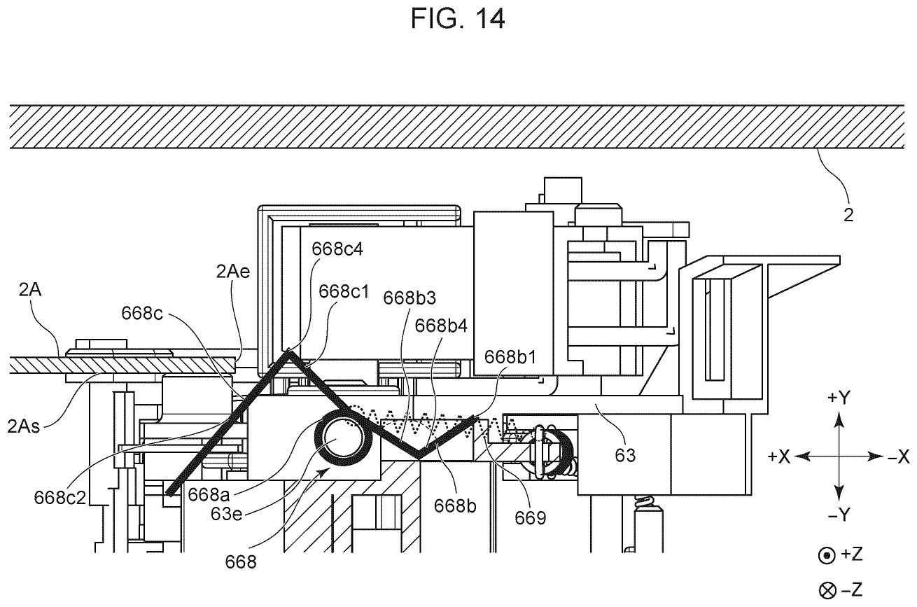

While the electrical contact point 668b1, as illustrated in FIG. 14, has a shape obtained by cutting a piece of metal wire at a right angle, the electrical contact point 668b1 may not necessarily need to have a fixed shape and may have, for example, a shape conforming to the edge of a cutting tool.

The second arm 668c includes a second extended portion 668c1, a third extended portion 668c2, a stopper portion 668c3, and a pressure bearing portion 668c4. The second extended portion 668cl extends from the other end of the coil portion 668a and in a direction intersecting the axial direction of the coil portion 668a. The pressure bearing portion 668c4 is a bent portion between the second extended portion 668c1 and the third extended portion 668c2. The third extended portion 668c2 extends in a direction orthogonal to the axial direction of the coil portion 668a but different from the direction in which the second extended portion 668c1 extends. The stopper portion 668c3 extends from an end of the third extended portion 668c2 that is farther from the coil portion 668a and in the axial direction of the coil portion 668a.

The spring receiving portion 668b2 receives the hook 669a of the second conductive spring 669. The second conductive spring 669 is a tension spring. The hook 669b of the second conductive spring 669 is in engagement with the lower hook 653b of the pressing spring 653. Thus, as illustrated in FIGS. 1A and 1B, the contact-point spring 668 is urged by the second conductive spring 669 in such a manner as to rotate about an axis B of the boss 63e (in a direction indicated by arrow C).

With the fixing device 6 detached from the apparatus body 2, the bent portion 668b5 of the first arm 668b under the urging force of the second conductive spring 669 is in contact with a receiving surface 63f included in the lower frame 63, whereby the contact-point spring 668 is positioned. The lower frame 63 includes a first protective wall 63h located on one side relative to the first-arm distal portion 668b4 in the axial direction of the coil portion 668a, and a second protective wall 63k located on the other side relative to the first-arm distal portion 668b4. That is, the first-arm distal portion 668b4 is located in the gap between the first protective wall 63h and the second protective wall 63k. In such a state, the electrical contact point 668b1 does not project or slightly projects from the first protective wall 63h and the second protective wall 63k. Thus, with the fixing device 6 detached from the apparatus body 2, the electrical contact point 668b1 is protected by the first protective wall 63h and the second protective wall 63k and is less likely to catch any other element.

On the other hand, with the fixing device 6 detached from the apparatus body 2, the pressure bearing portion 668c4 is bent in such a manner as to project from the lower frame 63. The lower frame 63 has a slit 63g and a stopper wall 63n that are located downstream of the boss 63e in a direction opposite to the recording-material conveyance direction. The slit 63g extends in a direction orthogonal to the axis B of the boss 63e. More specifically, the slit 63g extends in the recording-material conveyance direction. The stopper wall 63n is located adjacent to the slit 63g. The third extended portion 668c2 of the second arm 668c is fitted in the slit 63g. The stopper portion 668c3 is located upstream of the stopper wall 63n in the first axial direction and faces the stopper wall 63n. Therefore, with the rotation of the second conductive spring 669 in the direction of arrow C in which the pressure bearing portion 668c4 projects, the stopper portion 668c3 comes into contact with the stopper wall 63n.

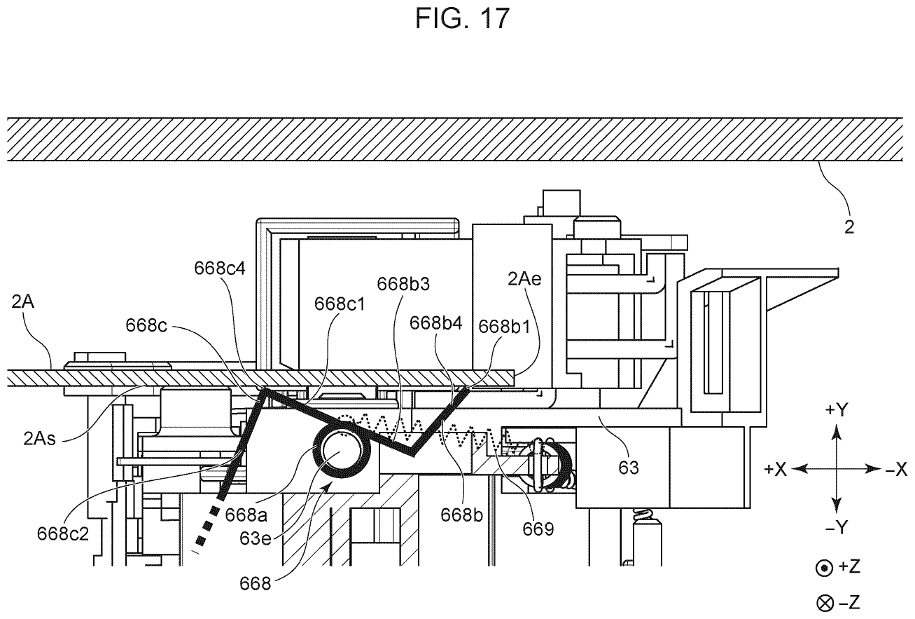

Referring to FIG. 17, the electrical continuity between the apparatus body 2 and other elements will be described. FIG. 17 is a top view of the fixing device 6 attached to the apparatus body 2. The apparatus body 2 includes the body conductor portion 2A, which has electrical conductivity. In the first embodiment, the body conductor portion 2A is an electrode. The contact-point spring 668 is located closer to the longitudinal center of the heating unit 61 than the body conductor portion 2A is.

The body conductor portion 2A is a metal plate serving as a frame of the apparatus body 2. The body conductor portion 2A may be electrically grounded. The body conductor portion 2A includes a contact surface 2As. The contact surface 2As forms a part of the body conductor portion 2A that is located at an end in the first direction. The contact surface 2As extends in the attaching direction (+X direction). The contact surface 2As is in contact with and electrically continuous with the electrical contact point 668b1. Therefore, the body conductor portion 2A allows static electricity to flow from the electrical contact point 668b1 to the ground.

Regarding the above described grounding structure that is provided for the fixing device 6, the brush body 660a is in contact with the outer peripheral surface 614b of the belt 614, whereby the brush body 660a and the belt 614 are electrically continuous with each other. The brush 660 is in contact with and electrically continuous with the first conductive plate 662. The resistor 663 is in contact with and electrically continuous with the second conductive plate 664. The second conductive plate 664 is in contact with and electrically continuous with the first conductive spring 667. The first conductive spring 667 is in contact with and electrically continuous with the pressing spring 653. The pressing spring 653 is in contact with and electrically continuous with the second conductive spring 669. The second conductive spring 669 is in contact with and electrically continuous with the contact-point spring 668. The electrical contact point 668b1 of the contact-point spring 668 is in contact with and electrically continuous with the body conductor portion 2A of the apparatus body 2. Thus, the body conductor portion 2A is electrically grounded.

Here, a group of the first conductive plate 662, the resistor 663, and the second conductive plate 664 may also be referred to as a first conductor portion 600a. That is, the first conductor portion 600a includes the first conductive plate 662, the resistor 663, the second conductive plate 664, and the first conductive spring 667 (first spring). The first conductor portion 600a is in contact with both the brush 660 (brush member) and the pressing spring 653 and provides electrical continuity between the brush 660 (brush member) and the pressing spring 653.

A group of the second conductive spring 669 and the contact-point spring 668 may also be referred to as a second conductor portion 600b. That is, the second conductor portion 600b includes the second conductive spring 669 and the contact-point spring 668. The second conductor portion 600b is in contact with both the pressing spring 653 and the body conductor portion 2A and provides electrical continuity between the pressing spring 653 and the body conductor portion 2A.

Hence, electric charge accumulated in the heating unit 61 is grounded through the brush 660, the first conductor portion 600a, and the second conductor portion 600b. Such a configuration enables the elimination of electric charge accumulated in the heating unit 61.

In the fixing device 6 according to the first embodiment, since the upper frame 64 and the lower frame 63 are made of resin, it is difficult to use the upper frame 64 and the lower frame 63 as part of the grounding structure. Nevertheless, as described above, providing electrical continuity to the body conductor portion 2A through the brush 660, the first conductor portion 600a, and the second conductor portion 600b enables the release of the electric charge from the heating unit 61.

In the fixing device 6 according to the first embodiment, the upper frame 64 (first frame) supports the first conductive plate 662, the resistor 663, and the second conductive plate 664. The upper frame 64 supports the first conductor portion 600a, the first conductor portion 600a is attached to the upper frame 64, or the upper frame 64 guides the first conductor portion 600a. Since the first conductor portion 600a is supported by the upper frame 64, the stability of the first conductor portion 600a against an external force is increased.

As described above, the coil portion 668a is wound around the boss 63e provided on the lower frame 63 and is thus supported by the lower frame 63. The lower hook 653b is in engagement with and supported by the frame engaging portion 63e1. Therefore, regarding the fixing device 6 according to the first embodiment, the lower frame 63 supports the second conductor portion 600b, or the second conductor portion 600b is attached to the lower frame 63.

### (Attaching Fixing Device to Apparatus Body)

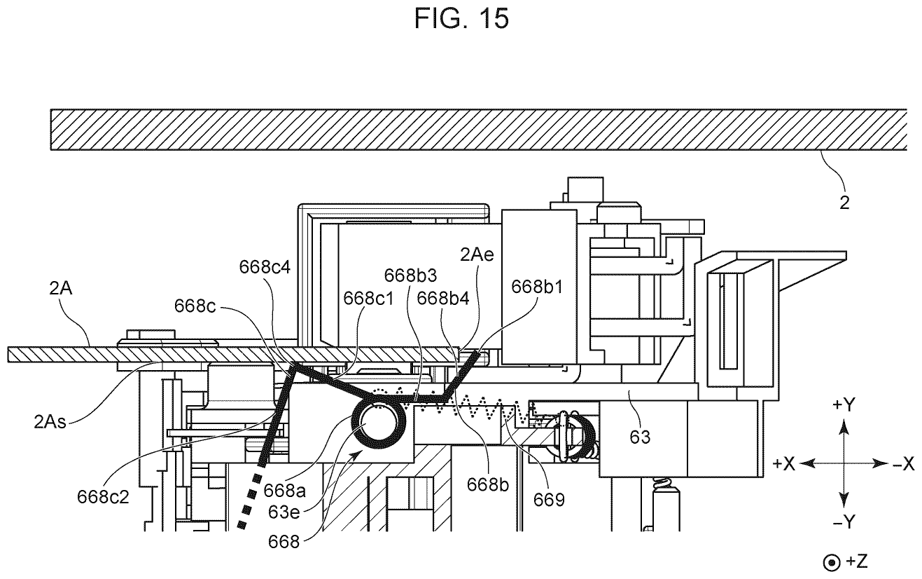

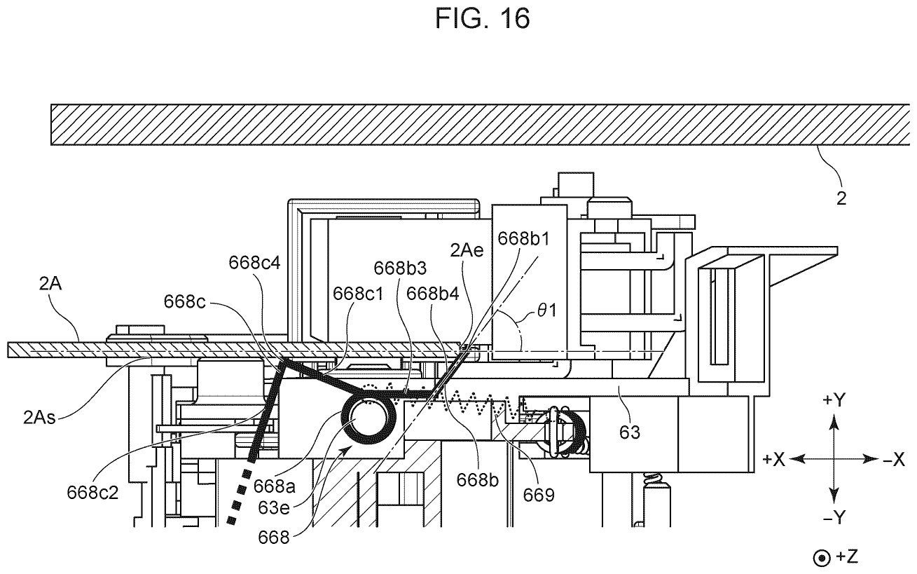

Behavior of the contact-point spring 668 during the process of moving the fixing device 6 to an attaching position and setting the fixing device 6 to the apparatus body 2 will now be described. The fixing device 6 is moved in the attaching direction (+X direction) relative to the apparatus body 2 and is thus set to the attaching position. FIG. 14 is a top view of the fixing device 6 that is yet to be set to the apparatus body 2. FIG. 15 is a top view of the fixing device 6 moved from the position in FIG. 14 into the apparatus body 2. FIG. 16 is a top view of the fixing device 6 further moved from the position in FIG. 15 into the apparatus body 2. FIG. 17 is a top view of the fixing device 6 further moved from the position in FIG. 16 into the apparatus body 2 and set to the attaching position relative to the apparatus body 2.

As illustrated in FIG. 14, the body conductor portion 2A includes a body upstream edge 2Ae. The body upstream edge 2Ae is an edge of the body conductor portion 2A that is located on the upstream side in the attaching direction. The body upstream edge 2Ae extends in the first direction (−Y direction). An end of the body upstream edge 2Ae that is located on the first-direction side is connected to an end of the contact surface 2As that is located on the side (−X side) opposite the attaching-direction side.

The position of the contact-point spring 668 before the fixing device 6 is set will be described. As illustrated in FIG. 14, before the fixing device 6 is set, the electrical contact point 668b1 and the pressure bearing portion 668c4 are located upstream of the body upstream edge 2Ae in the attaching direction. In the first direction, the pressure bearing portion 668c4 is located upstream of the contact surface 2As. Part of the third extended portion 668c2 is at the same position in the first direction as the body upstream edge 2Ae. In the first direction, the electrical contact point 668b1 is located downstream of the body upstream edge 2Ae.

When the fixing device 6 at the position illustrated in FIG. 14 is moved in the attaching direction relative to the apparatus body 2, the third extended portion 668c2 comes into contact with the body upstream edge 2Ae. The third extended portion 668c2 is oriented toward the first-direction side while extending in the attaching direction. Therefore, the third extended portion 668c2 is pushed by the body upstream edge 2Ae, and the second arm 668c rotates counterclockwise about the boss 63e. That is, while the third extended portion 668c2 advances in the attaching direction, the second arm 668c coming into contact with and being pushed by the body upstream edge 2Ae moves toward the −Y side. Accordingly, the pressure bearing portion 668c4 comes into contact with the contact surface 2As (FIG. 15). With the counterclockwise rotation of the second arm 668c, the coil portion 668a and the first arm 668b also rotate counterclockwise about the boss 63e. Thus, as illustrated in FIG. 15, while the pressure bearing portion 668c4 is in contact with the contact surface 2As, the first-arm distal portion 668b4 reaches a position coinciding with the body upstream edge 2Ae in the first direction. When the fixing device 6 at the position illustrated in FIG. 15 is further moved in the attaching direction relative to the apparatus body 2, the first-arm distal portion 668b4 comes into contact with the body upstream edge 2Ae as illustrated in FIG. 16. Specifically, since the second arm 668c comes into contact with the body conductor portion 2A and moves in the first direction, the first-arm distal portion 668b4 (distal portion) moves in a second direction, which is opposite to the first direction, and comes into contact with the body upstream edge 2Ae.

FIG. 16 illustrates a state where the first-arm distal portion 668b4 (distal portion) starts to come into contact with the body upstream edge 2Ae. When the first-arm distal portion 668b4 starts to come into contact with the body upstream edge 2Ae, the first-arm distal portion 668b4 (distal portion) is oriented toward the first-direction side while extending in the attaching direction. FIG. 16 illustrates the state where the first-arm distal portion 668b4 starts to come into contact with the body upstream edge 2Ae. An angle θ1 formed between the direction in which the first-arm distal portion 668b4 extends and the attaching direction is an acute angle (smaller than 90 degrees). If the angle θ1 is an obtuse angle (greater than 90 degrees), the contact-point spring 668 and the body upstream edge 2Ae strongly interfere with each other, resulting in possible deformation of the contact-point spring 668. Therefore, the present disclosure configures the angle θ1 as an acute angle, thereby reducing deformation of the contact-point spring 668. A predetermined value for deforming the contact-point spring 668 at an angle θ1 is set within a range of 30 degrees≥θ1>0 degrees.

In the first embodiment, to make the angle θ1 an acute angle, an angle θ2 formed between the extended portion 668b3 and the first-arm distal portion 668b4 is set to an obtuse angle (greater than 90 degrees) as illustrated in FIG. 10B. The angle θ2 may also be regarded as an angle at which the bent portion 668b5 (first bent portion) is bent. Setting the angle θ2 to an obtuse angle makes it easier to set the angle θ1 to an acute angle. Accordingly, deformation of the contact-point spring 668 is reduced. In the first embodiment, the angle θ2 is set within a range of 135 degrees±20 degrees (155 degrees≥θ2≥115 degrees). If the contact-point spring 668 is designed such that the angle θ2 becomes smaller than 115 degrees, the variation in production may make the angle θ2 90 degrees or smaller. As described above, if the angle θ1 is an obtuse angle (greater than 90 degrees), the contact-point spring 668 and the body upstream edge 2Ae strongly interfere with each other, resulting in possible deformation of the contact-point spring 668. Therefore, the first embodiment employs a configuration that satisfies θ2≥115 degrees. On the other hand, it may be difficult to produce the contact-point spring 668 such that the angle θ2 becomes 155 degrees or greater. Therefore, considering the ease of production of the contact-point spring 668, the first embodiment employs a configuration that satisfies 155 degrees≥02.

When the fixing device 6 at the position illustrated in FIG. 16 is further moved in the attaching direction relative to the apparatus body 2, the first-arm distal portion 668b4 that is in contact with the body upstream edge 2Ae moves toward the first-direction side while advancing in the attaching direction. Accordingly, the electrical contact point 668b1 (distal end) is guided toward the contact surface 2As and comes into contact with the contact surface 2As. When the fixing device 6 is further moved in the attaching direction, the sharp edge of the electrical contact point 668b1 scratches the contact surface 2As while moving along the contact surface 2As. Therefore, even if the contact surface 2As is covered with any coating or oxide film, such coating or film is scratched off by the electrical contact point 668b1, whereby the electrical connection between the body conductor portion 2A and the electrical contact point 668b1 is maintained in a good manner. Eventually, the fixing device 6 is set to the attaching position as illustrated in FIG. 17.

(Eliminating Electric Charge from Rotary Pressing Member)

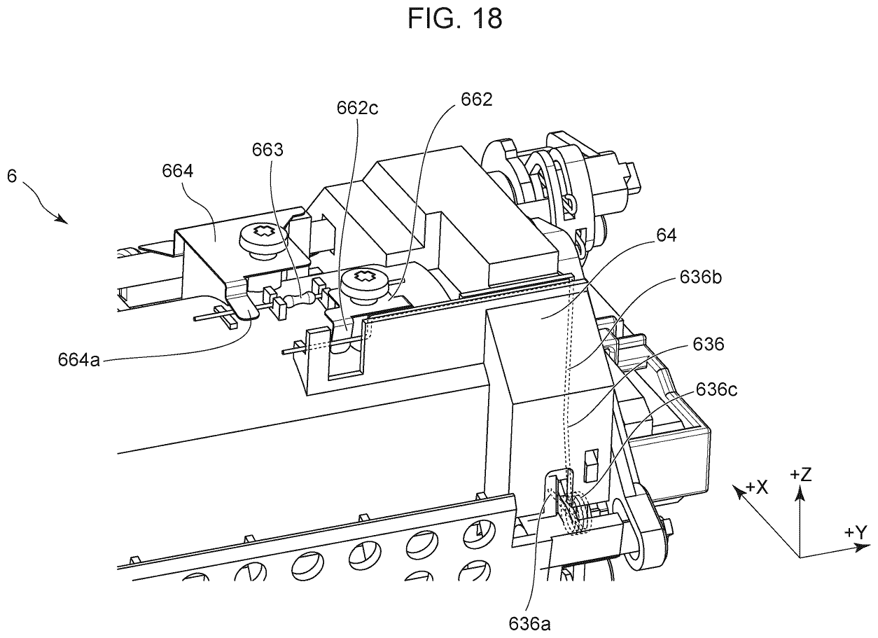

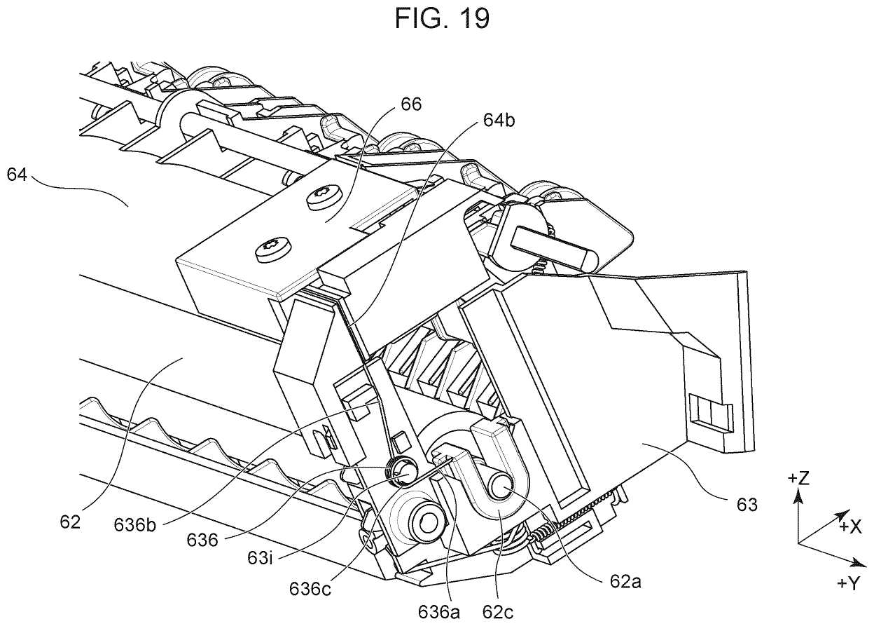

If an electrically charged sheet S is conveyed to the rotary pressing member 62, the rotary pressing member 62 may be electrically charged. If a fixing operation is performed with the rotary pressing member 62 electrically charged, the quality of fixing may deteriorate. Hence, the fixing device 6 according to the first embodiment employs a structure of eliminating electric charge accumulated in the rotary pressing member 62. Referring to FIGS. 18 and 19, the structure of eliminating electric charge accumulated in the rotary pressing member 62 will now be described. FIGS. 18 and 19 are perspective views of the fixing device 6. The fixing device 6 includes a helical torsion spring 636. The helical torsion spring 636 includes a coil portion 636c, a first arm portion 636a, and a second arm portion 636b. The lower frame 63 has a boss 63i at an end thereof on the first-axial-direction side (+Y side). The coil portion 636c is wound around the boss 63i and is thus supported by the boss 63i (lower frame 63). That is, the boss 63i is fitted in the coil portion 636c. The second arm portion 636b extends from one end of the coil portion 636c toward the static eliminator 66 and is in engagement with a groove 64b provided in the upper frame 64. In the first embodiment, the groove 64b is provided in the upper frame 64. Alternatively, a guide portion having the same function as the groove 64b may be provided as a separate member on the upper frame 64. The first arm portion 636a extends from the other end of the coil portion 636c toward the bearing 62c and is in contact with the bearing 62c. With the second arm portion 636b fitted in the groove 64b and with the first arm portion 636a being in contact with the bearing 62c, the angle formed between the first arm portion 636a and the second arm portion 636b is smaller than the free angle of the helical torsion spring 636. Therefore, the first arm portion 636a and the second arm portion 636b rotate such that the angle formed therebetween is widened. More specifically, the first arm portion 636a rotates in a direction toward the bearing 62c. Thus, the contact pressure between the first arm portion 636a and the bearing 62c is increased, whereby the electrical connection is stabilized. On the other hand, the second arm portion 636b rotates in a direction away from the bearing 62c. In the first embodiment, the second arm portion 636b is fitted in the groove 64b, whereby the rotation of the second arm portion 636b is limited by the groove 64b. That is, the groove 64b serves as a guide portion that guides the second arm portion 636b toward the static eliminator 66. Since the groove 64b limits the rotation of the second arm portion 636b, the force that causes the first arm portion 636a to rotate toward the bearing 62c is maintained. Therefore, the contact pressure between the first arm portion 636a and the bearing 62c is maintained to be high.

The bearing 62c and the shaft 62a are in contact with each other. Therefore, the rotary pressing member 62, the bearing 62c, and the helical torsion spring 636 are electrically connected to one another. As illustrated in FIG. 18, the second arm portion 636b is in contact with the contact portion 662c. That is, the helical torsion spring 636 (third conductor portion) is in contact with both the first conductor portion 600a and the bearing 62c and thus provides an electrical connection (electrical continuity) between the shaft 62a (rotary shaft) and the body conductor portion 2A. Therefore, the rotary pressing member 62 (shaft 62a), the bearing 62c, the helical torsion spring 636, and the static eliminator 66 are electrically connected to one another.

As described above, the static eliminator 66 is electrically connected to the body conductor portion 2A. Therefore, the rotary pressing member 62 is electrically connected to the body conductor portion 2A. That is, the rotary pressing member 62 is connected to the ground, which enables the elimination of electric charge accumulated in the rotary pressing member 62, thereby suppressing deterioration in the quality of fixing due to the charging of the rotary pressing member 62.

In the fixing device 6 according to the first embodiment, the grounding structure for the rotary pressing member 62 and the grounding structure for the heating unit 61 are not separate from each other, and the grounding structure for the heating unit 61 also serves as the grounding structure for the rotary pressing member 62. Such a configuration releases electric charge from the rotary pressing member 62 through the resistor 663. A configuration in which the rotary pressing member 62 is grounded involves the following problem. While the transfer roller 51 and the rotary pressing member 62 are conveying the sheet S, the voltage applied to the transfer roller 51 may be transmitted as an electric current through the sheet S to the rotary pressing member 62, which may lower the transfer voltage for the transfer roller 51. This is because the rotary pressing member 62 connected to the ground facilitates the flow of the electric current from the transfer roller 51 to the rotary pressing member 62. Hence, in the first embodiment, the resistor 663 is connected to the rotary pressing member 62. Thus, the electric current becomes less likely to flow from the transfer roller 51 to the rotary pressing member 62.

In the first embodiment, since the grounding structure for the heating unit 61 also serves as the grounding structure for the rotary pressing member 62, adding another resistor in addition to the resistor 663 is not needed, unlike a case where the grounding structure for the rotary pressing member 62 and the grounding structure for the heating unit 61 are provided separately from each other.

The fixing device 6 employs the pressing spring 653 as a grounding structure. The first conductor portion 600a is included in the upper frame 64, and the second conductor portion 600b is included in the lower frame 63. Therefore, the first conductor portion 600a and the second conductor portion 600b are spaced apart from each other in the vertical direction. Hence, the first embodiment employs the pressing spring 653 extending in the vertical direction to connect the first conductor portion 600a and the second conductor portion 600b to each other. Since the pressing spring 653 is employed, no additional conductive member that electrically connects the first conductor portion 600a and the second conductor portion 600b to each other is necessary.

### Second Embodiment

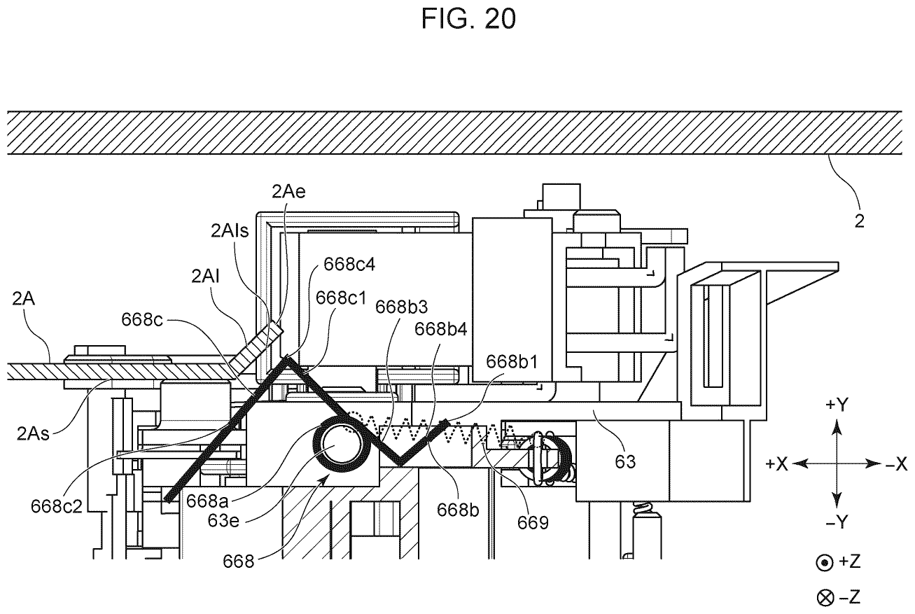

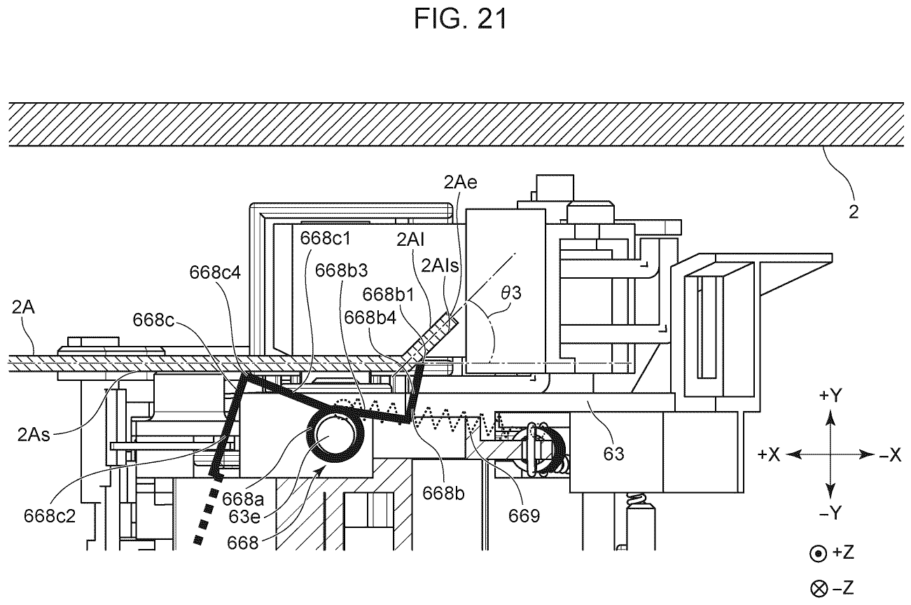

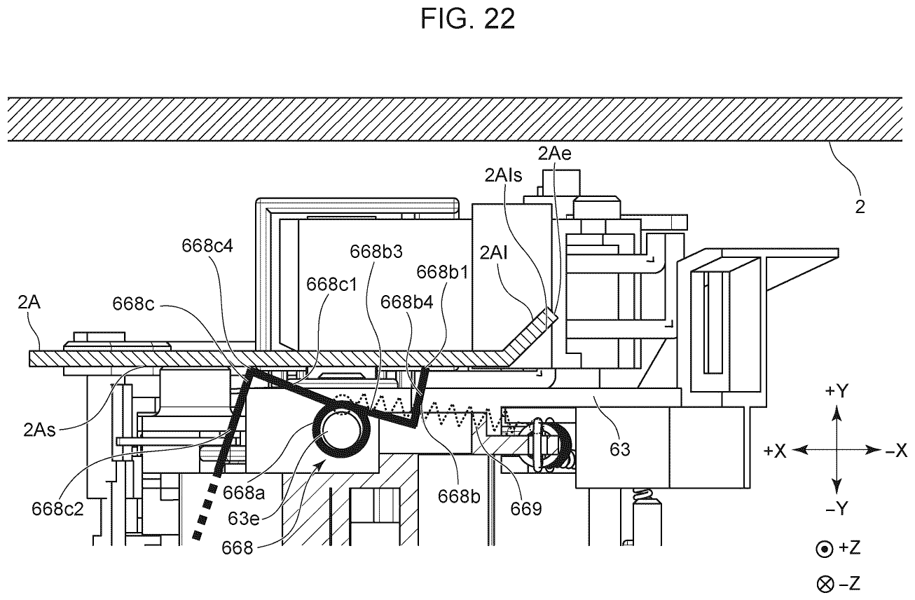

The second embodiment differs from the first embodiment in that the body conductor portion 2A includes an introducing part 2AI to ease the interference between the first-arm distal portion 668b4 and the body conductor portion 2A. FIG. 20 is a top view of the fixing device 6 that is yet to be set to the apparatus body 2. FIG. 21 is a top view of the fixing device 6 further moved from the position in FIG. 20 into the apparatus body 2. FIG. 22 is a top view of the fixing device 6 further moved from the position in FIG. 21 into the apparatus body 2 and set to the attaching position relative to the apparatus body 2. As illustrated in FIG. 20, the body conductor portion 2A includes the introducing part 2AI. The introducing part 2AI serves as a guide portion that guides the first-arm distal portion 668b4 toward the contact surface 2As. The introducing part 2AI has an introducing surface 2AIs. The introducing surface 2AIs is a guide surface that is oriented toward the first-direction side while extending in the attaching direction and is connected to the contact surface 2As. When the fixing device 6 at the position illustrated in FIG. 20 is moved in the attaching direction, the pressure bearing portion 668c4 is guided toward the contact surface 2As while being pushed by the introducing surface 2AIs. That is, the second arm 668c is guided by the introducing surface 2AIs and moves toward the first-direction side. With the counterclockwise rotation of the second arm 668c, the coil portion 668a and the first arm 668b also rotate counterclockwise about the boss 63e. Specifically, with the movement of the second arm 668c in the first direction, the first-arm distal portion 668b4 moves in the second direction opposite to the first direction and comes into contact with the introducing surface 2AIs (guide portion).

FIG. 21 illustrates the state of the fixing device 6 where the first-arm distal portion 668b4 starts to come into contact with the introducing surface 2AIs. As described above, the introducing surface 2AIs is oriented toward the first-direction side while extending in the attaching direction. An angle θ3 formed between the attaching direction and the introducing surface 2AIs is an acute angle. Therefore, the first-arm distal portion 668b4 is guided toward the first-direction side. Hence, the interference between the first-arm distal portion 668b4 and the body conductor portion 2A is eased. A predetermined value for deforming contact-point spring 668 at an angle θ3 is set within a range of 30 degrees≥θ1>0 degrees.

When the fixing device 6 at the position illustrated in FIG. 21 is further inserted into apparatus body 2, the first-arm distal portion 668b4 guided by the introducing surface 2AIs moves toward the first-direction side while advancing in the attaching direction. The electrical contact point 668b1 (distal end) is guided to the contact surface 2As. The electrical contact point 668b1 moves in the attaching direction while being in contact with the contact surface 2As. Eventually, as illustrated in FIG. 22, the fixing device 6 reaches the attaching position and is set to the apparatus body 2.

In the second embodiment, the introducing surface 2AIs guides the first-arm distal portion 668b4 to the contact surface 2As. Thus, deformation of the contact-point spring 668 is reduced.

While the angle θ2 in the first embodiment is an obtuse angle, the angle θ2 may be set to an acute angle (smaller than 90 degrees), as illustrated in FIG. 22, as long as the angle θ1 is set to an acute angle. If the angle θ2 is set within a range of 90 degrees±10 degrees, the contact pressure applied from the electrical contact point 668b1 to the contact surface 2As becomes greater than in a case where the angle θ2 is an obtuse angle. A contact-point spring 668 designed to form an angle θ2 within a range of 90 degrees±10 degrees is easier to produce than the one designed to form an angle θ2 that is extremely obtuse or acute.

While the introducing part 2AI according to the second embodiment is included in the body conductor portion 2A, the introducing part 2AI may be separate from the body conductor portion 2A. The shape of the introducing part 2AI may be a hemmed shape or a curled shape.

### Third Embodiment

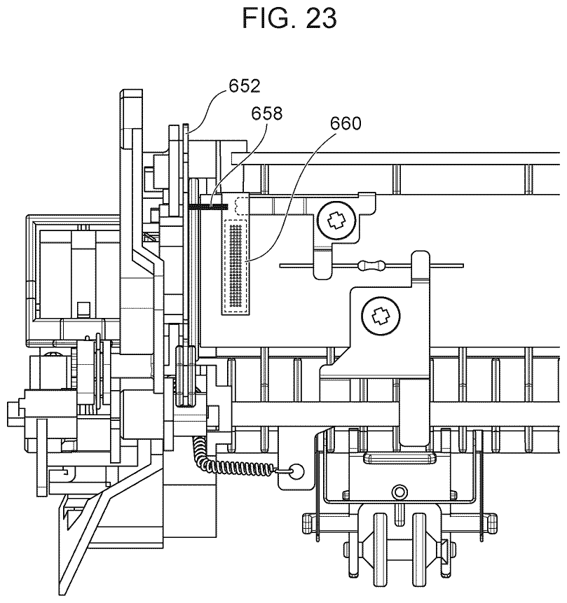

A third embodiment will now be described with reference to FIG. 23. FIG. 23 is a top view of the fixing device 6. The grounding structure employed in the first embodiment is configured to release static electricity through the brush 660, the first conductor portion 600a, and the second conductor portion 600b. Alternatively, the pressing arm 652 may be used as a part of the grounding structure. Specifically, the pressing arm 652 may be made of an electrically conductive material so that the brush 660, the pressing arm 652, and the pressing spring 653 are electrically continuous with one another. In such a case, the grounding structure from the pressing spring 653 to the body conductor portion 2A is the same as in the first embodiment, and the description thereof is incorporated herein by reference, for conciseness.

The fixing device 6 includes an intermediate conductor portion 658 that is electrically conductive. The intermediate conductor portion 658 is a metal member. The intermediate conductor portion 658 may be any member that is electrically conductive. As illustrated in FIG. 23, the intermediate conductor portion 658 is in contact with and electrically continuous with both the brush 660 and the pressing arm 652. In the second embodiment, the intermediate conductor portion 658 is electrically continuous with the belt 614 through the brush 660. Thus, stable contact is achieved with a small force so that the belt 614 is not damaged.

Instead of providing the brush 660, the intermediate conductor portion 658 directly contacts the belt 614, so that the intermediate conductor portion 658 and the belt 614 become electrically continuous with each other. In that case, since the brush 660 is omitted, the grounding structure becomes less expensive. The intermediate conductor portion 658 is separate from the transmission member 617a or the pressing arm 652. Alternatively, the intermediate conductor portion 658 may be integrated with the transmission member 617a or the pressing arm 652 into a single body.

As another alternative, instead of providing the intermediate conductor portion 658, the transmission member 617a illustrated in FIG. 5 may be made of an electrically conductive material. In that case, the transmission member 617a is in contact with and electrically continuous with both the belt 614 and the pressing arm 652.

### Fourth Embodiment

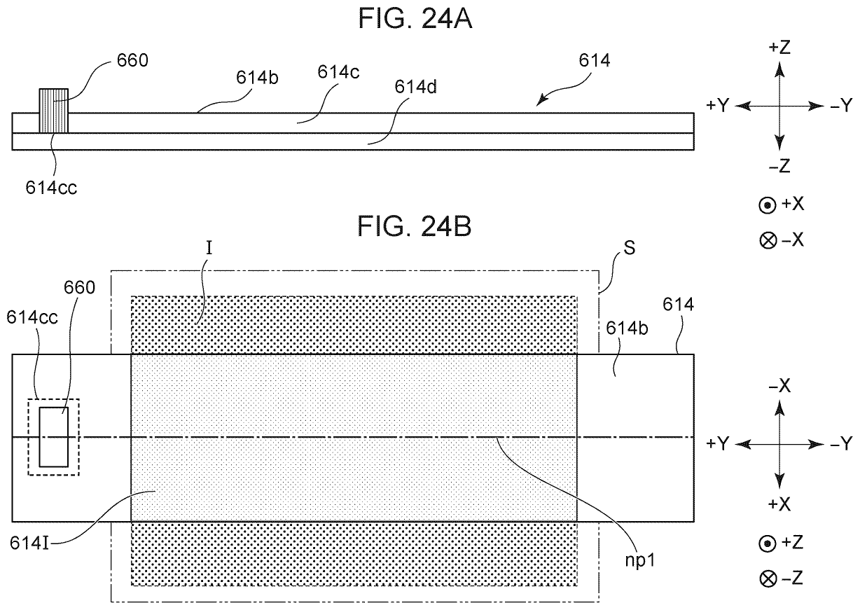

A fourth embodiment will now be described with reference to FIGS. 24A and 24B. FIGS. 24A and 24B schematically illustrate part of the belt 614. The outer peripheral surface 614b of the belt 614 to which the brush body 660a is in contact may be formed by a layer of coating, such as fluorocarbon resin. Alternatively, for example, if the belt 614 is an electrically conductive member such as a metal sleeve, the coating layer may be partially removed so that the metal layer (electrically conductive layer) is exposed.

As illustrated in FIG. 24A, the belt 614 includes an electrically conductive layer 614d, and an insulating layer 614c that covers the electrically conductive layer 614d from the outer peripheral side of the belt 614. For example, the electrically conductive layer 614d serves as a base layer of the belt 614. The electrically conductive layer 614d includes an exposed portion 614cc that is not covered by the insulating layer 614c and is exposed on the outer peripheral side of the belt 614. The brush 660 is in contact with the exposed portion 614cc. Thus, electric charge accumulated in the heating unit 61 is released to the ground through the above-described grounding structure.

FIG. 24B illustrates a state where a sheet S having a toner image I is located at the nip np1 so that the toner image I is fixed by the fixing device 6. The toner image I formed on the sheet S illustrated in FIG. 24B is of the largest size possible in the generating-line direction of the belt 614 (the Y direction). A portion of the belt 614 that coincides with the toner image I in the generating-line direction of the belt 614 (the Y direction) is referred to as a belt first portion 614I. At least part of the exposed portion 614cc is located outside the belt first portion 614I in the generating-line direction of the belt 614. Likewise, at least part of the brush 660 is located outside the belt first portion 614I in the generating-line direction of the belt 614. That is, with respect to the generating-line direction of the belt 614, at least part of the exposed portion 614cc and at least part of the brush 660 are located outside an area of the belt 614 where a recording material having the largest width conveyable at the nip np1 passes. With the exposed portion 614cc designed as above, the influence upon the quality of fixing is made smaller than in a case where the exposed portion 614cc is located inside the belt first portion 614I in the generating-line direction of the belt 614.

In the first embodiment, the first conductor portion 600a included in the grounding structure for the rotary pressing member 62 and the grounding structure for the heating unit 61 includes the pressing spring 653. Alternatively, the first conductor portion 600a may not necessarily need to include the pressing spring 653. That is, the first conductor portion 600a includes an electrically conductive member that is in contact with the second conductor portion 600b.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-203408, filed Nov. 21, 2024, which is hereby incorporated by reference herein in its entirety.

What is claimed is:

1. A fixing device configured to attach to an image forming apparatus, the fixing device comprising:
a heating unit including an endless belt and a heater, the heater being provided on an inner peripheral side of the belt and configured to heat the belt;
a pressing roller configured to form a nip in cooperation with the heater and with the belt in between;
a pressing arm configured to press the heating unit against the pressing roller;
an electrically conductive pressing spring configured to urge the pressing arm such that the heating unit is pressed against the pressing roller;
an electrically conductive bearing configured to support a rotary shaft of the pressing roller;
a frame made of resin and supporting the bearing;
an electrically conductive brush member provided in contact with the belt;
a first conductor portion provided in contact with the brush member and the pressing spring such that the brush member and the pressing spring are electrically connected to each other;
a second conductor portion provided in contact with the pressing spring and a body conductor portion of the image forming apparatus, such that the pressing spring and the body conductor portion are electrically connected to each other; and
a third conductor portion provided in contact with the first conductor portion and the bearing such that the rotary shaft and the body conductor portion are electrically connected to each other.

2. The fixing device according to claim 1, wherein the first conductor portion includes a resistor.

3. The fixing device according to claim 1, further comprising:
an other frame made of resin,
wherein the first conductor portion is attached to the other frame,
wherein the other frame is located above the frame with the fixing device attached to an apparatus body of the image forming apparatus, and
wherein the second conductor portion is attached to the frame.

4. The fixing device according to claim 3,
wherein the third conductor portion includes a helical torsion spring,
wherein the helical torsion spring includes:
a coil portion supported by a boss provided on the frame;
a first arm portion extending from one end of the coil portion and being in contact with the bearing; and
a second arm portion extending from an other end of the coil portion and being in contact with the first conductor portion, and
wherein the other frame has a groove configured to engage and limit rotation of the second arm portion.

5. The fixing device according to claim 3,
wherein the other frame includes a first guide configured to guide a surface of recording material conveyed at the nip, and
wherein the surface faces the heating unit.

6. The fixing device according to claim 1,
wherein the belt includes an electrically conductive layer and an insulating layer, the insulating layer covering the electrically conductive layer from an outer peripheral side of the belt,
wherein the electrically conductive layer includes an exposed portion that is exposed on the outer peripheral side of the belt,
wherein the brush member is in contact with the exposed portion of the electrically conductive layer,
wherein at least part of the exposed portion is located outside an area of the belt where a recording material having a largest width conveyable at the nip passes, and
wherein the width of the recording material is relative to a generating-line direction of the belt.

7. The fixing device according to claim 3, further comprising:
a cam shaft rotatably supported by the frame; and
a cam configured to rotate in such a manner as to change a pressing force applied from the pressing arm to the pressing roller of the heating unit, the cam being configured to be supported by and rotate with the cam shaft.

8. The fixing device according to claim 7,
wherein the first conductor portion includes an overlapping portion overlapping the cam shaft with the fixing device attached to the apparatus body, viewed in a vertical direction, and
wherein, with the fixing device attached to the apparatus body, the overlapping portion is located below the cam shaft.

9. The fixing device according to claim 7,
wherein the other frame supports the cam shaft.

10. The fixing device according to claim 1,
wherein the first conductor portion includes a first spring, and
wherein the first spring extends in a rotation-axis direction of the pressing arm and is electrically connected to the pressing arm.

11. The fixing device according to claim 7,
wherein the first conductor portion includes a first spring,
wherein the frame includes a shaft supporting portion configured to support the cam shaft and extending in a vertical direction,
wherein recording material is conveyed at the nip in a conveyance direction, and
wherein a support downstream end of the shaft supporting portion is located on a downstream side in the conveyance direction, with the support downstream end located between the cam shaft and the first spring.

12. The fixing device according to claim 11,
wherein the support downstream end is configured to guide the first spring to limit a movement of the first spring toward the cam shaft.

13. The fixing device according to claim 6,
wherein the electrically conductive layer is a base layer of the belt.

14. The fixing device according to claim 1,
wherein the second conductor portion includes a helical torsion spring, and
wherein, with the fixing device attached to an apparatus body of the image forming apparatus, the helical torsion spring is in contact with the body conductor portion.

15. The fixing device according to claim 1,
wherein the body conductor portion is an electrode.

16. The fixing device according to claim 7,
wherein the first conductor portion includes a cam-shaft contact portion that is in contact with the cam shaft.

17. A fixing device to be attached to an image forming apparatus, the fixing device comprising:
a heating unit including an endless belt and a heater, the heater being provided on an inner peripheral side of the belt and configured to heat the belt;
a pressing roller configured to form a nip in cooperation with the heater and with the belt in between;
an electrically conductive bearing supporting a rotary shaft of the pressing roller;
a frame made of resin, the frame configured to support the bearing;
an electrically conductive brush member provided in contact with the belt;
a first conductor portion provided in contact with the brush member in such a manner as to be electrically connected to the brush member;
a second conductor portion provided in contact with the first conductor portion and a body conductor portion of the image forming apparatus, such that the first conductor portion and the body conductor portion are electrically connected to each other; and
a third conductor portion provided in contact with the first conductor portion and the bearing such that the rotary shaft and the body conductor portion are electrically connected to each other,
wherein the second conductor portion includes a helical torsion spring,
wherein the helical torsion spring includes a coil portion and an arm extending from one end of the coil portion, and
wherein, with the fixing device attached to the apparatus body, a distal end of the arm is in contact with the body conductor portion.

18. The fixing device according to claim 17,
wherein the body conductor portion includes an electrode, and
wherein, with the fixing device attached to the apparatus body, the distal end of the arm is in contact with the electrode.
